(19) United States
(12) Patent Application Publication
(10) Pub. No.: US 2006/0256739 A1
(43) Pub. Date: Nov. 16, 2006

(54) Flexible multi-media data management

(76) Inventors: Kenneth Seier, Waltham, MA (US); Coleen Crawford, Raynham, MA (US)

Correspondence Address: THE LAW OFFICES OF STEVEN MCHUGH, LLC, 46 WASHINGTON STREET, MIDDLETOWN, CT, 06457, US

(21) Appl. No.: 11/356,951

(22) Filed: Feb. 18, 2006

Related U.S. Application Data
(60) Provisional application No. 60/654,303, filed on Feb. 19, 2005.

(51) Int. Cl. H04Q 11/00

(52) U.S. Cl. 370/261

(57) ABSTRACT

A method for managing data using a data management scheme is provided, wherein the method includes generating a first data set and a second data set, wherein the first data set is generated independently from the second data set. The method further includes introducing the first data set and the second data set into the data management scheme, wherein the data management scheme assigns a first identification tag to the first data set and a second identification tag to the second data set and responsive to at least one of the first identification tag and the second identification tag, correlating the first data set with the second data set to obtain a final data set.

### RELATED APPLICATIONS

The present application claims priority of U.S. Provisional Patent Application Ser. No. 60/654,303 filed Feb. 19, 2005 the contents of which is incorporated herein by reference in its entirety.

### FIELD OF THE INVENTION

This invention relates generally to the management of data and more particularly to a method and system for managing data using flexible data management methods and integration tools.

### BACKGROUND OF THE INVENTION

In most situations involving the management of data, it is important that the data be collected, managed and recorded in a reliable, consistent and accurate manner to be as organized and unambiguous as possible. This will ensure that the data obtained will be as ‘fresh’ and reliable as at the date that it was collected. Failure to reliably, consistently and accurately collect, record and manage data may result in a host of undesirable results, such as conflicts between different data set revisions that may have been maintained and edited by different entities. At a minimum, this type of conflict can result in data corruption by confusing data sets. At a maximum, this type of conflict can result in a loss of life situation (for data sets that are applied to certain technologies, such as the medical examination field) or may have serious legal ramifications due to chain of custody issues.

For example, consider the situation of a pathologist performing a postmortem examination on a suspected murder victim. Typically, as the pathologist is collecting and recording data on the subject, laboratory tests may be conducted on tissue samples, clothes samples and other evidence collected. Because these data sources do not typically merge their data together in a reliable and consistent format, a significant amount of time may be needed to organize and manage the collected data. Not only does this make data correlation more difficult, if the data is not collected and cataloged in a consistent, accurate and reliable manner any conclusion drawn from this data may be subject to question. This is undesirable because the conclusions of a postmortem examination in a criminal case may have severe consequences, in some cases life or death consequences, each step of the data collection process must be controlled, well documented, well organized, accurate and reliable.

As another example, consider the case where several physicians are collecting data on a series of patients that are exhibiting similar symptoms of an illness. If the data collected is not reliably cataloged and managed or if multiple entities have access to the data, the diagnosis drawn from this data may be delayed or incorrect potentially resulting in the loss of life of current and future patients. The data management process is even more confused when several individuals or entities have access to the collected data.

### SUMMARY OF THE INVENTION

A method for managing data using a data management scheme is provided, wherein the method includes generating a first data set and a second data set, wherein the first data set is generated independently from the second data set. The method further includes introducing the first data set and the second data set into the data management scheme, wherein the data management scheme assigns a first identification tag to the first data set and a second identification tag to the second data set and responsive to at least one of the first identification tag and the second identification tag, correlating the first data set with the second data set to obtain a final data set.

A method for implementing a data management scheme is provided, wherein the method includes examining a subject of interest and implementing the data management scheme, wherein the data management scheme includes, generating a first data set and a second data set, wherein the first data set is generated independently from the second data set. The data management scheme further includes assigning a first identification tag to the first data set and a second identification tag to the second data set and responsive to at least one of the first identification tag and the second identification tag, correlating the first data set with the second data set to obtain a final data set.

### BRIEF DESCRIPTION OF DRAWINGS

The foregoing and other features and advantages of the present invention will be better understood from the following detailed description of illustrative embodiments, taken in conjunction with the accompanying drawings in which:

FIG. 1 is a top level block diagram illustrating a Data Management Tool (DMT) in accordance with an exemplary embodiment;

FIG. 2 is a top level block diagram illustrating a Plug-In Module for use with the Data Management Tool (DMT) of FIG. 1;

FIG. 3 is a top level block diagram illustrating one embodiment of a relational architecture for the DMT of FIG. 1;

FIG. 4 is a top level block diagram illustrating one embodiment of a Plug-In relational architecture for the DMT of FIG. 1;

FIG. 5 is a top level block diagram illustrating one embodiment for customizing user interfaces for the DMT of FIG. 1;

FIG. 6 is a top level block diagram illustrating one embodiment of an element for the DMT of FIG. 1;

FIG. 7 is a top level block diagram illustrating one embodiment of nested elements for the DMT of FIG. 1;

FIG. 8 is a top level block diagram illustrating one embodiment of XDC cross-database concurrency for the DMT of FIG. 1;

FIG. 9 is a top level block diagram illustrating one embodiment a custom media for the DMT of FIG. 1; and

FIG. 10 is a block diagram illustrating a method for managing data using the data management tool of FIG. 1.

### DETAILED DESCRIPTION OF THE INVENTION

A Flexible Multi-Media Data Management tool (hereinafter “DMT”) is provided and allows a user to quickly and easily build rich, multi-media documents though a customizable/configurable interface which connects data in meaningful relationships and allows for the secure sharing of data with others users. This may be accomplished via a Windows® based graphical user interface (GUI) which allows a user to take advantage of customization utilities and advanced data management features by providing the user with several capabilities, such as the ability to integrate multi-media data, including images, audio, video, diagrams, reports, 3^{rd} party files, the ability to save information to a local secure file and/or synchronize data with a database and/or the ability to search, sort and/or filter files and/or file data using powerful relational tools.

The DMT allows a user to use state of the art security tools to protect sensitive data and to safely and securely share information with colleagues via the ability to encrypt and compress data for secure transmission. Additionally, the DMT provides a user the ability to secure all or part of a file to prevent unwanted/unsupervised modification of the file, the ability to create read-only files for exchange and collaboration with outside agencies and/or the ability to generate dynamic multi-media presentations for data delivery. Furthermore, the DMT allows for the use of customized plug-in modules (PIM's) to enhance and increase functionality to address the requirements of specific industries, to help users save time and to increase effectiveness and work flow speed by providing the ability to quickly build data from libraries of industry specific data, such as diagrams, reports and/or icons. Additionally, the DMT allows a user to increase clarity and consistency with standardized symbols/reporting and/or the ability to improve productivity and/or work flow using secure data exchange.

For example, the DMT may include a Forensic Investigator (FI) PIM, which is an expert enhancement module designed specifically for forensic investigators and criminal prosecutors to meet the needs of the medico-legal industry. The FI PIM may allow one or more forensic investigators to build a multi-media investigation file(s) with video, audio, images, x-rays, diagrams, 3^{rd} party files, existing hardcopies and/or internal/external documentation. The FI PIM may provide the forensic investigator with the ability to integrate multi-media data from the crime scene, autopsy suite and medical sources in an easy to reference file(s) using libraries of standard post-mortem and laboratory reports. Furthermore, the DMT may allow a user to import agency-specific paperwork/forms and provide the ability to notate and/or cross-reference data in easy file formats. Built in tools and/or libraries may also be provided to allow a user to build clear, consistent visual documentation and to present that documentation in a secure, easy to present format. This may be accomplished by providing the user with the ability to create and edit skeletal, anatomical and odontological diagrams from either a library provided with the DMT or via an imported agency-specific diagram(s)/library(s). As such, the user may have the ability to drag and drop, rotate and resize symbolic trauma icons on diagrams for clear, consistent, non-prejudicial documentation, as well as the ability to document signature fractures and unusual trauma with a freehand drawing tool and/or the ability to build read-only files and presentations for use in court and/or jury deliberations. The user may also share information seamlessly with allied agencies and files may be password protected before distribution to other entities to help manage work flow and/or accountability. Encryption technologies may be used to encrypt sensitive data transmitted over the internet, thus allowing one entity the ability to securely share information with another entity for enhance data integration.

As another example, the DMT may include a Crime Scene (CS) PIM, which is an expert enhancement module designed specifically for criminal investigators and criminal prosecutors to meet the needs of the criminological industry. The CS PIM may be composed of “content proper” palettes which provide useful resources throughout an investigation, wherein each form of evidence may be used to support the next, thus enabling an investigator to generate powerful testimony through multiple forms of data. Thus, the CS PIM may allow Police Departments, Homicide Units, and Road Officers the capability of digitally documenting evidence collected at a crime scene and/or accident scene for later processing, such as data correlation, data dissemination and/or accident reconstruction. The user may then merge/combine this data with an external file and/or specific data, such as the Medical Examiner's data and/or transfer this merged file and/or data to a different entity for further investigation. The DTM may also allow a user to disconnect from the network to collect photos, build diagrams and/or catalog evidence directly on site in the field.

It should be appreciated that the DMT allows for the resolution of complex data sharing issues by resolving differences between file/data versions that have been maintained and edited by different organizations. The DMT allows for the maintenance of different file identifiers (case numbers, patient ids etc.) for the same file between organizations, the ability to enable different users to password secure all and/or parts of a file to help maintain data integrity throughout the work flow or process and/or the ability to track file access and modification. It should be further appreciated that the DMT provides a flexible architecture that adapts to the needs of a user by providing the ability to scale from a single-user interface to a multi-user application. Moreover, the DMT allows for on-site standalone use that provides the user with the ability to work from either a centralized database and/or a localized database. Additionally, the DMT is easily customized to meet specific company, agency and/or departmental requirements and/or includes the ability to use single and/or multiple Add-On Modules (AOMs) and/or PIMs that allow for easy upgrades and/or performance enhancements. Furthermore, the DMT is capable of easy integration with existing systems/software packages by providing the ability to be installed on any platform suitable to the desired end purpose, such as Microsoft® Windows 2000, Windows XP® PC, Macintosh and/or LINUX. The DMT also includes the ability to use enhanced relational tools available by integrating with Microsoft® SQL Server or Oracle databases, the ability to integrate with existing 3^{rd} party applications and the ability to support many tablet and/or touch-screen technologies.

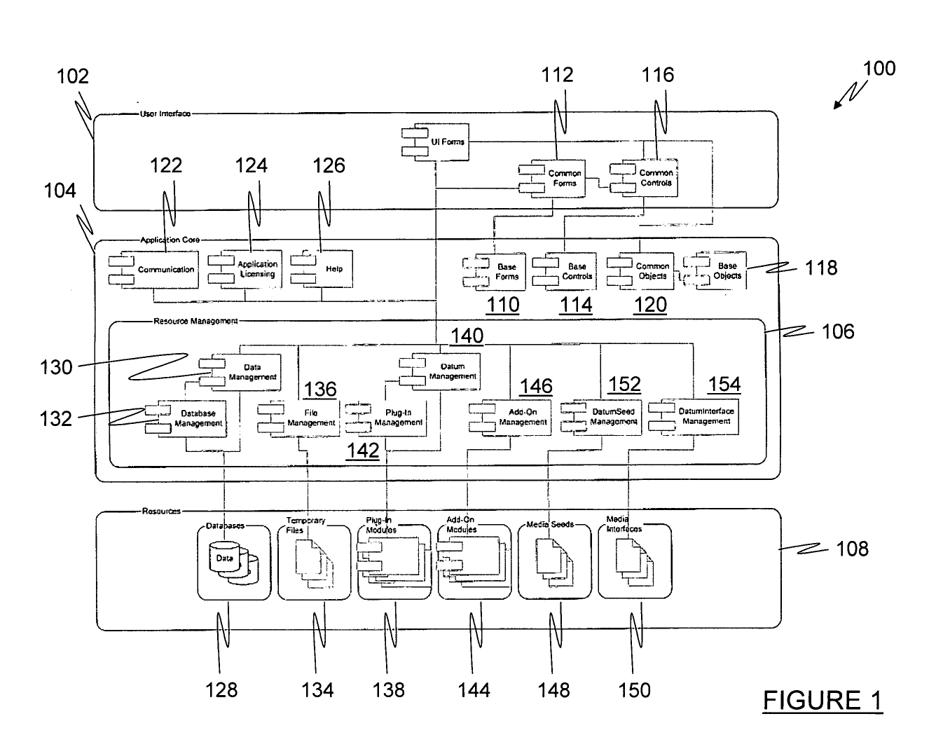

Referring to FIG. 1, a high-level block diagram of a DMT 100 is shown and includes four main components: a User Interface (UI) component 102, an Application Core (AC) component 104, a Resource Management (RM) component 106 and a Resource component 108. The UI component 102 allows a user to access a Base Form Module 110 via a Common Form Module 112, a Base Control Module 114 via a Common Control Module 116 and a Base Object Module 118 via a Common Object Module 120. Additionally, the UI component 102 allows a user to a Communication Module 122, an Application Licensing Module 124, Help Module 126 and the RM component 106. The RM component 106 allows the user to manage data via UI component 102 access to internal/external Databases 128 via a Data Management Module 130 and/or a Database Management Module 132. The RM component 106 also allows the user to manage internal/external temporary files 134 via a File Management Module 136. Additionally, the RM component 106 allows the user to manage internal/external plug-in modules 138 via a Datum Management Module 140 and a Plug-In Management Module 142. In a similar fashion, the RM component 106 allows the user to manage internal/external add-on modules 144 via an Add-On Management Module 146. Moreover, the RM component 106 allows the user to manage internal/external Media Seeds 148 and Media Interfaces 150 via a Datum Seed Management Module 152 and a Datum Interface Management Module 154.

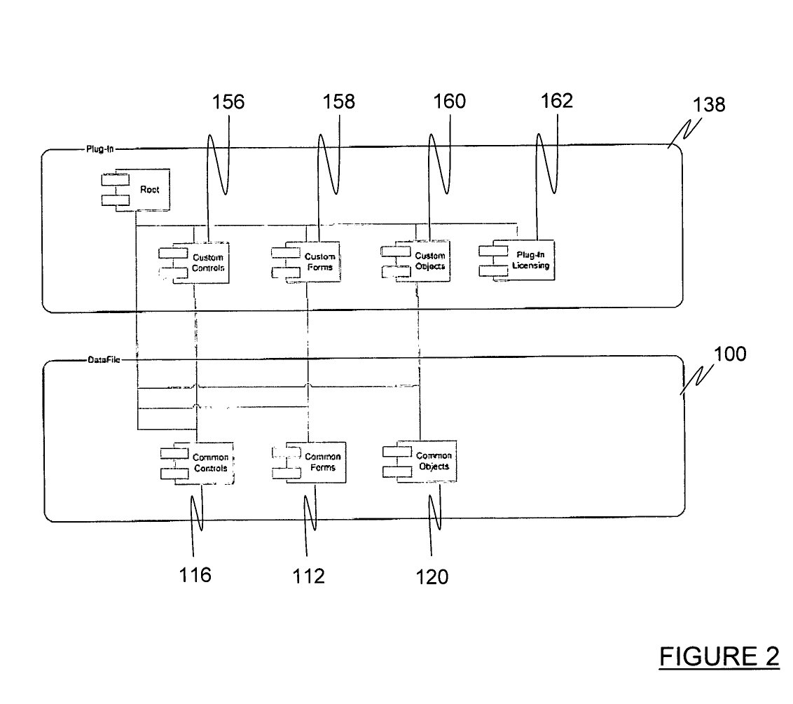

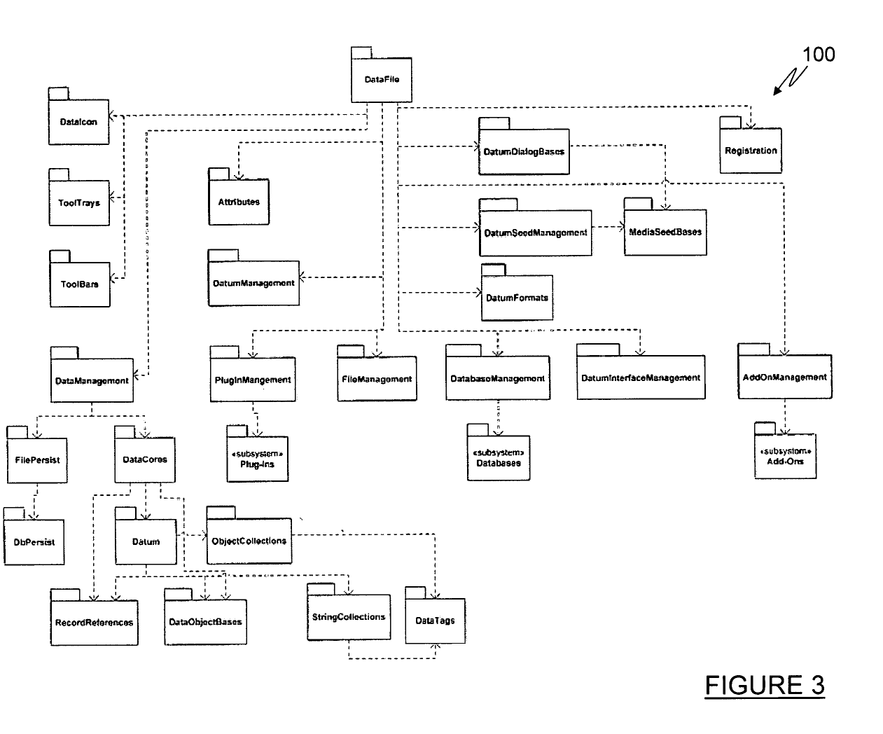

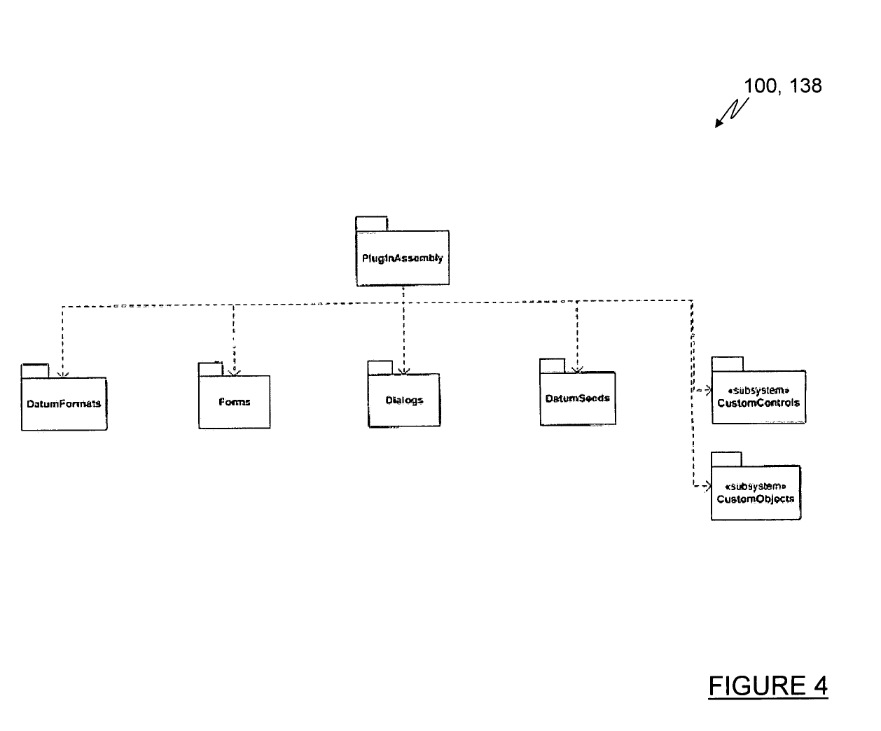

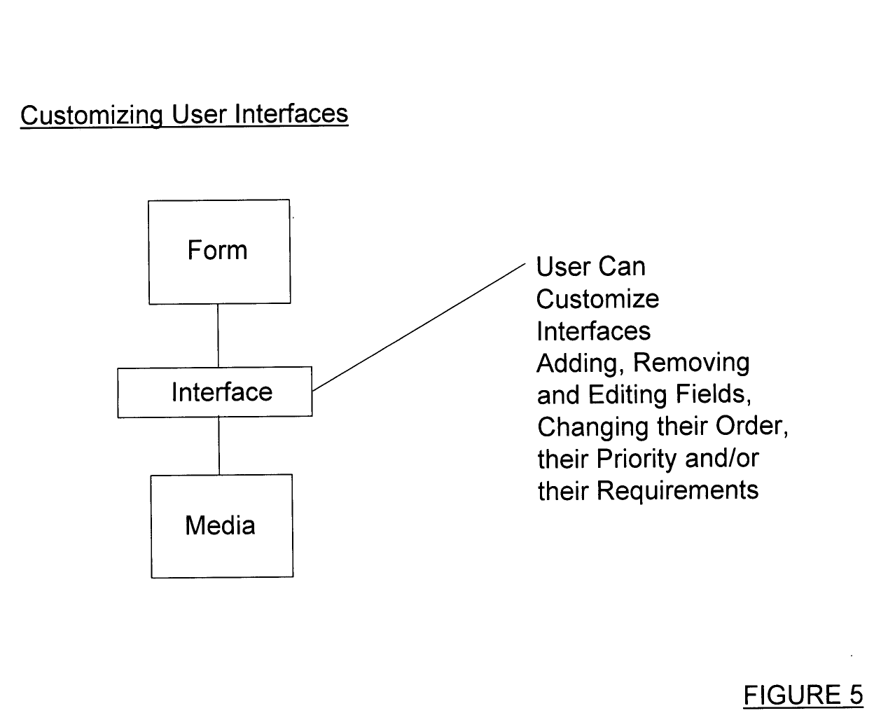

Referring to FIG. 2, FIG. 3 and FIG. 4 a high-level block diagram of one embodiment of a Plug-In Module 138 having a Custom Control Module 156, a Custom Form Module 158, a Custom Object Module 160 and a Plug-In Licensing Module 162 is shown, wherein the Custom Control Module 156 is communicated with the Common Control Module 116, the Custom Form Module 158 is communicated with the Common Form Module 112 and the Custom Object Module 160 is communicated with the Common Object Module 120. The UI component 102 may provide the user access to common forms 112 and common controls 114 used by the AC component 104 and/or the Plug-In Management Module 108 to display data and to give a user access to the functionality of the AC component 104, the Plug-In Management Module 108 and the Add-On Management Module 146. The AC component 104 may provide the user access to the base functionality needed to execute standard management tasks, such as generic data retrieval, manipulation and persistence, resource management, application licensing, help/support functionality, basic communication utilities and/or base control, forms and/or objects used in Plug-In Modules 138 that ensure a consistent base set of functionality and/or ease of integration with the application core. Referring to FIG. 5, the DTM 100 via the Plug-In Management Module 108 allows a user to modify the functionality of the UI component 102 to satisfy the data requirements of a specific industry and may include customized forms, customized data interfaces (DI) and customized data objects (DO) that allow users from a specific industry to quickly and easily modify the UI to suit specific requirements.

It should be appreciated that the Plug-In Management Module 108 may rely on reflection, the Base Control Module 114, the Base Forms Module 110 and the Base Object Module 118 resident in the AC component 104 for integration with the AC component 104 and the UI component 102. The Add-On Management Module 146 provides enhanced functionality for the AC component 104 and/or the Plug-In Management Module 142 and improves internal functionality, such as security and data persistence, add core functionality for all Plug-In Modules 138, tie into peripheral devices, such as bar-code scanners and/or security cameras, expand Plug-In Module functionality and/or other improve application abilities. Similarly, to the Plug-In Management Module 142, the Add-On Management Module 146 may rely on reflection, the Base Control Module 114, the Base Forms Module 110 and the Base Object Module 118 resident in the AC component 104 for integration with the AC component 104 and the UI component 102.

The DMT 100 allows a user to create, edit, store, secure, share, reproduce, display and manage text, multi-media and multiple party data, wherein data and data management functionality may be accessed though any interface suitable to the desired end purpose, such as client based (PC, Max, Unix/Linux, etc.) or web based (web browser) user interface (UI). The UI component 102 may integrate with the AC component 104, wherein the UI component 102 and/or the AC component 104 behavior may be enhanced and/or modified with additional functional capabilities, such as common and/or customized expert Plug-In Module's 138 and/or functionality Add-On Module's 144. Via the UI component 102 data may be collected from a user through any interface suitable to the desired end purpose, such as a Graphical User Interface and/or though data importation. The data may then be stored in any device using a format suitable to the desired end purpose, such as a flexible self-referential data format. Data, data work flow, data communication, data access and data structures may also controlled using static/dynamic rules and/or parameters that may be preset and/or user defined. For example, a user may customize the existing UI component 102 and/or create a customized UI component through editors.

To correlate data, individual data may be tagged to allow the linking of all or part(s) of at least one datum to all or part(s) of another datum for navigation, display and nested content. Data may be displayed in the GUI using any relationship suitable to the desired end purpose, such as symbolic-object relationships that may follow the established tagged and non-tagged relationships. Moreover, data may be saved (persisted) to any device and/or method suitable to the desired end purpose, such as flat-files and/or a datastore/database. Data may also be exported from the program in any format or combination of formats suitable to the desired end purpose, such as custom and/or common formats and data may be encrypted and compressed. Data may be accessible using any method and device suitable to the desired end purpose, such as network, internet and wireless technologies or the application may work disconnected or as a stand alone.

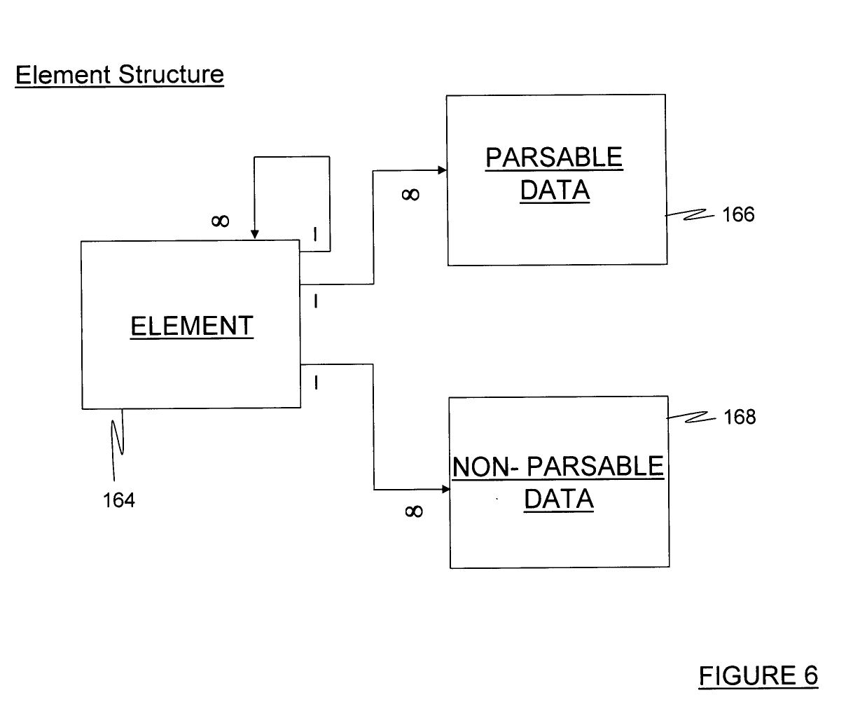

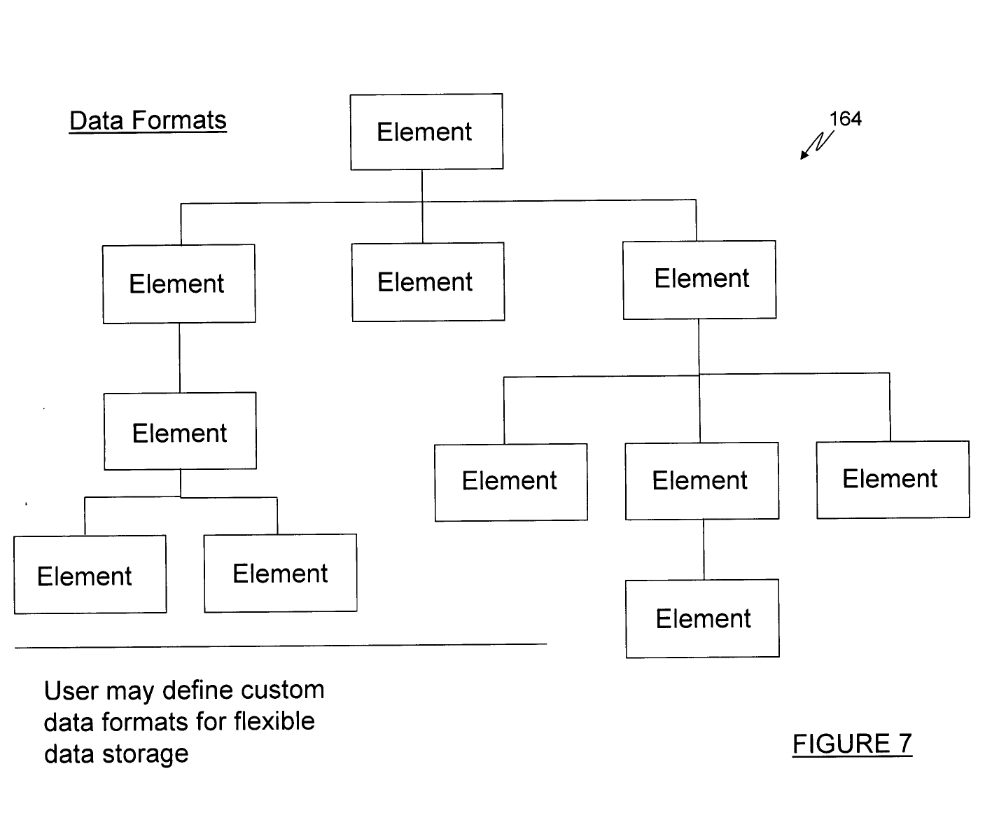

Referring to FIG. 6 and FIG. 7, the term datum may refer to a single name/value pair contained in an element 164 and may be distinguished as parsable data 166 and/or non-parsable data 168. The term element 164 may refer to a multiple and/or single unit of DMT data and can contain both parsable data 166 and non-parsable data 168 and may make reference to other element objects or Tagged Data. The term Media may refer to a formatted element 164, containing specific data, permissions and rules for use in the DMT 100. The term Tag may refer to an identifier specifying a part or parts of an element 164 or datum. Tags can denote regions in display (2D), space (3D), time, frequency, color or any other quantifiable measurement. The term Set may refer to a grouping of elements 164 that are commonly contained within another element 164.

As such, data entered into the DMT 100 may be tagged either as individual data and/or as a group data set to allow all and/or part of one data set to be linked with all and/or part of another data set for data navigation, data display and/or nested content. All or a portion of the data set may be displayed via the GUI using any relationship suitable to the desired end purpose, such as symbolic-object relationships that may follow any established tagged and/or non-tagged relationships. Moreover, all or a part of the data set may be saved (persisted) to any device, global and/or local, via any method suitable to the desired end purpose, such as flat-files and/or a data-store/database. All or a part of the data set may be exported from the DMT 100 in any format and/or combination of formats suitable to the desired end purpose, such as custom and/or common formats and the data set may be encrypted and compressed for secured storage and/or transmission. The data set may be accessible using any method and/or device suitable to the desired end purpose, such as network, internet, extranet and wireless technologies or the application may work disconnected or as a stand alone entity.

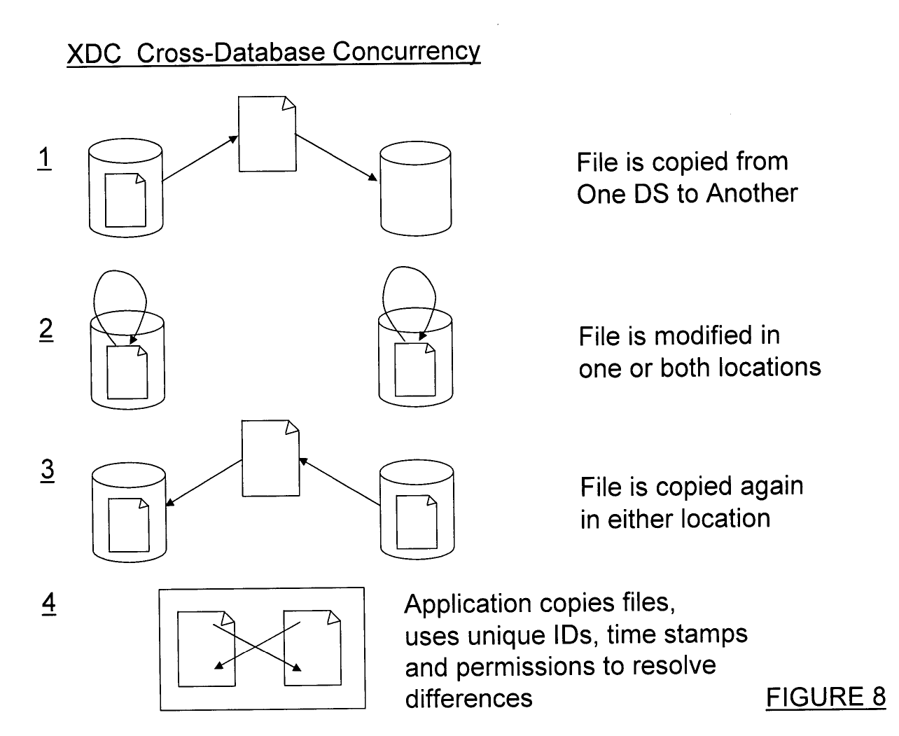

It should be appreciated that the DMT 100 may refer to a data collection/storage model that allows for customizable, flexible, multi-media, data manipulation in an infinite number of referential configurations and Relational Tagged Data (RTD) may refer to a tagging model that allows tagged data to be associated with any part of any object, wherein the relationship between tagged data may be configurable and user defined. This provides a high level of connection and interactivity between different data. Referring to FIG. 8, Cross-Datastore Concurrency (XDC) may refer to a datastore record model designed to allow data to be saved and modified in multiple datastores and to reconcile differences when they are later synched. As such, XDC allows for the effective handling of changes and for data to be moved from one database to another. Additionally, Object-Oriented Datastore (OOD) may refer to a relational database access model designed to implement complex object model using inheritance hierarchies and object casting and that allows for early bound object functionality in both AC component 104 and any PIM's 138.

It should be appreciated that expert Plug-In Module's 138 may be used to modify and enhance the UI component 102 and the AC component 104 to provide industry specific tools and User Interfaces. Additionally, the Add-On modules 144 may be used to enhance the UI component 102, the AC component 104 and/or the Plug-In Module's 138 to change functionality and/or to integrate new functionality and/or peripheral devices. Conversely, a user may operate the DMT 100 with or without the Plug-In Modules 138 and/or the Add-On Modules 144 functionality. Similarly, the user may operate the DMT 100 with multiple expert Plug-In Module's 138 and/or Add-On Module's 144 operating simultaneously, wherein the expert Plug-In Module's 138 and/or Add-On Module's 144 may operate independently. Additionally, the expert Plug-In Module's 138 and/or Add-On Module's 144, may integrate with each other to provide combined functionality, the expert Plug-In Module's 138 and/or Add-On Module's 144 may require each other to provide nested or slaved functionality and/or the expert Plug-In Module's 138 and/or Add-On Module's 144 may rely on relationships, reflection, common interfaces and object inheritance to integrate with the UI component 102 and/or the AC component 104. Furthermore, a user may operate the DMT 100 via a local machine and/or connect to a host interface via an internet/extranet browser. The DMT 100 architecture may be designed to allow multiple front ends to integrate with an isolated AC component 104 to make the DMT 100 more scalable and each component (UI component 102, AC component 104, Plug-In Module 138 and Add-On Module 144) may be registered and licensed separately.

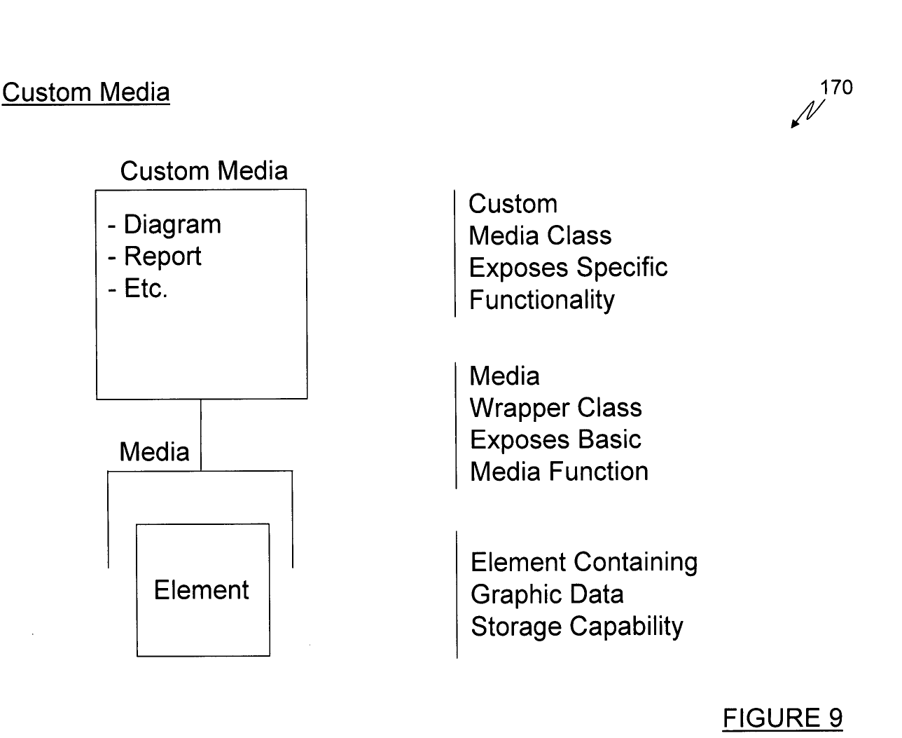

It should be appreciated that the UI component 102 and the AC component 104 may expose a number of common interfaces and classes designed to improve communication with other components, interfaces and/or classes. The expert Plug-In Module's 138 and/or Add-On Module's 144 may integrate using a combination of dedicated integration classes, object inheritance, late-bound referencing and dynamic reflection. Additionally referring to FIG. 9, a user may define custom Media 170 and/or use existing Media from the AC component 104, the expert Plug-In Module's 138 and/or the Add-On Module's 144. A user may also define Fields and Rules for the Media 170. For example, a user may define Data Formats (ie. relationships between Media 170) and roles and then may assign users to those roles, assign approvals to selected processes and relate the approvals to roles, assign permissions to the Media 170 using roles and/or approvals, assign relationships to approvals, assign events to Media 170 and/or approvals and modify existing Media 170, rules, relationships, roles and approvals.

The user may also use the Media 170 defined in the AC component and/or in an installed expert Plug-In Module 138 and/or Add-On Module 144, or the user may create a new Media type, such as an employee Media. Moreover, the user may assign data fields and data requirements to the media by predefined criteria, for example such as name and type, a text field called name, a numeric field called department, a numeric field called salary, a boolean field called hired and an image field called photo. Furthermore, the user may specify permissions based on roles, such as allowing only users with a human resources role to create an employee or view a salary field. It is possible to configure the DMT 100 such that any user may view the name and image fields, but only authorized users may modify designated fields, such as the name, salary and image fields. In a similar manner, the user may also assign approvals based on roles. For example, if an employee hire requires the approval of a human resources (HR) manager and a manager from the department in which the employee hire will be working, the user may assign approval only to those managers. Additionally, the user may also relate Approvals into a process and/or the user may assign permissions based on both permissions and approvals. For example, before hiring, any Manager may change the employee name, whereas after hire only an HR Manager may change the name. The user may also assign relationships between media. For example, every employee must have an associated employee as a manager. Moreover, the user may create roles though inheritance from custom Roles or Roles defined in the AC component 104, installed Plug-In Modules 138 and/or installed Add-On Modules 144. For example, an HR Manager role may have all of the permissions/approvals of the HR role and the Manager role. The user may also modify custom and/or built in Media, Roles, Approvals, Permissions and Relationships to meet their particular needs. For example, rules may be created and maintained in a separate series class and files and may be attached to the post compile. The Rules classes may include definitions of Rules and Rule relationships, tools for creating and editing rules and classes for integrating the rules with the basic application functionality and may be integrated with the Rule Management component.

Referring back to FIG. 7, collected data may be stored in a self-referencing data element object 164, wherein the data element object 164 may contain any number of other data element objects 164 and wherein the data element object 164 may hold data in name/value paired collections. The data element objects 164 may have separate collections for parsable data 166 and/or non-parsable data 168, may be customizable with Media wrappers and may be structured with Data Formats for defining relationships and integrating with Rules to create approvals and/or permissions. A user may use one of the built-in Media and/or data formats or the user may import and/or build their own formats. For example, the DMT 100 may include an Image Media that stores a single image in a preferred format, such as a bitmap format, a series of symbols associated with that image (highlights, circles, arrows) and information about that image, such as the time the image was created and the original file name. Additionally, an installed expert Plug-In Module 138 and/or Add-On Module 144 may define its own Media 170. For example, a Medical Examiner Plug-In Module may define a report that integrates text data with a single, static image and a user may define their own Media by creating a list of fields and their types, wherein the user may then define the proscribed method of Media interaction. As another example, one basic format may be to have a single File Media that holds multiple instances of an Image Media, a Diagram Media and a 3^{rd} Party Media. Whereas, more complex formats may require certain numbers and types of Media be nested inside each other, limit the type of media used and/or create multiple levels of data (Media inside media inside media). As such, the Media class can be thought of as a wrapper for the generic Element class, exposing a set of behaviors that may be used to derive a number of more customized classes, such as Image Media, Diagram Media, Audio Media and Third Party Media. Even more specialized classes that inherit from these or directly from included Media may be implemented using any method/device suitable to the desired end purpose, such as an expert Plug-In Module 138 and/or Add-On Module 144.

It should be appreciated that a user may modify digital forms used with Media 170 from the AC component 104, the Plug-In Modules 138 and/or the Add-On Modules 144. Additionally, a user may create digital forms to interface with custom Media 170 and may integrate digital forms with Roles, Permissions, Approvals, etc. A user may create and/or modify Media and Drop-Icon Libraries for desired content and/or organization and may persist modified libraries to a database for group-wide consistency. Libraries may be uploaded and reconciled using XDC and new interfaces/forms may be associated with Media or Media Library Files. Furthermore, a user may modify an existing form using a form editor, showing some fields and hiding others, to create and/or customize the form for a specific use or a user may create an entirely new form to interact with existing and/or newly created custom Media 170. A user may create a new form to integrate with the Image Media or they may create a form with fields corresponding to other features, such as the custom Employee Media discussed hereinabove. Additionally, a user may tie in defined Roles, Approvals and Permissions to make the forms reflect the rules based data and/or data processes. For example, the form may prevent a department manager from seeing the Salary field while an HR employee would be able view this field. Moreover, a user may create media libraries or modify existing libraries. For example, someone using the Medical Examiner PIM may add new anatomical diagrams to the library, remove or rename existing diagrams, add new trauma icons to the palate or split the Symbol palate into multiple sub-palates. Libraries may be maintained in multiple formats and files, such as .dat and .lib files, and may be managed through provided tools, such as a PlugInManagement component and a LibraryManagement component. Media Interfaces may be stored as collection objects used to relate forms to Media 170 and form controls to Media fields. The interface may be used to integrate Media 170, Rules and forms and when users customize the Media 170, Media Interfaces and/or Rules, the form may automatically adapt (IE, the Interface manages the system and produces the UI form automatically.)

Additionally, a user may open one or more Sets and/or Elements 164 simultaneously. A new Set or Element 164 may be created and a Set and/or Element 164 may be associated with a Plug-In Module 138 and/or an Add-On Module 144 to give access to enhanced Plug-In Module 138 and/or Add-On Module 144 functionality. A Plug-In Module 138 and or an Add-On Module 144 may be associated with a Data Set/Datum at creation time and/or single/multiple Plug-In Modules 138 and/or an Add-On Modules 144 may be associated with the Data Set/Datum. It is contemplated that a list of Plug-In Modules 138 and/or an Add-On Modules 144 associated with a Data Set/Datum may be modified later and applicable Plug-In Modules 138 and/or Add-On Modules 144 may self-load in conjunction with associated Plug-In Modules 138 and/or Add-On Modules 144. A previously persisted Set or Element 164 may be opened from a datastore, a flat file and/or from any currently available DataFile database available via network/internet/wireless methods and/or devices to allow a user to search multiple databases simultaneously. Additionally, Sets/Elements 164 in a database may be selected using any parsable data 166 or the user may create a new file. The user may be allowed to choose single/multiple Plug-In Modules 138 and/or Add-On Modules 144 from a list of Plug-In Modules 138 and/or Add-On Modules 144. For example, a user may choose to build a file with both the Medical Examiner and Crime Scene tools located in those two Plug-In Modules 138. Then all available and relevant Add-On Modules 144 would be loaded and depending on the security and data format rules, a user may be prompted for additional information including, but not limited to, passwords, file names and/or other starter values.

Associated Plug-In Modules 138 and/or Add-On Modules 144 and some starter values may be changed later. Previously saved files may be opened from flat files or from databases on the user machine, locally, over a network and/or over the internet. Opened files may contain individual Media 170 and/or Media Sets in read-write and/or read-only formats. Files opened from a flat file may use standard OS tools to locate and choose the file and files opened from a database may be selected from a list of all files on all or some of the available databases (Homicide, but not Vice or Larceny), selected from a filtered list of files (Show all files on the Homicide database that were closed in the past 3 weeks) or searched for on all or some of the databases by any parsable data (show me all files on the Homicide database that had a female victim killed with a knife and that has the word “alley” somewhere in the file). Moreover, files may be selected and persisted through the Data Management Module 130. If a database is chosen, the connection to that database may also be maintained through the Database Management Module 132 via the Data Management Module 130.

Furthermore, a user may add new Elements 164 to a Data Set. Elements 164 may be added as new empty Elements 164, Elements 164 may be added from flat files and/or Elements 164 may be added as common file formats (images, sound, video, text). Additionally, Elements 164 may be added as 3^{rd} party proprietary file formats (Word, PDF, 3D etc.) and/or added as exported Datum files. Also, Elements 164 may be added from a database and/or using seed values from Plug-In Modules 138. A user may merge two or more Data Sets into a single Data Set and current data may be manipulated. DataSet, Datum, Sub-Datum or DataTags may be searched, sorted and/or filtered and the data may be edited. Common data formats (images, video, etc.) may be edited using tools in the AC component 102 or one of the currently loaded Plug-In Modules 138. Third party data formats may be edited using an external call to the third party application or any embedded (sub-licensed) applications. DataFile data formats may be edited using tools in the AC component 104 or one of the currently loaded Plug-In Modules 138. Data may be deleted and/or added. Once a file is open, a user may begin editing the contents of that file. If the file is a Set, the user may add new images, diagrams, reports or third party files to the Set as new Media. The user may then open and manipulate the individual media. For example, the user may modify text and/or change a date and/or the user may add new symbols to a diagram and/or add highlights to a report. The user may modify data in the same way changing resolution of images, cropping diagrams, rotating, moving and/or resizing attached symbols and so on. The user may also edit a third party file (like a Word document) by opening a version of the third party application through the UI component 102. When the user adds a Media 170, it may be from a previously saved file, it may be created as a new Media 170 using information in one of the Media Libraries or it may be based on a file the user imports. The user may also delete Media 170 from a given Set. All data may be stored as a set of nested elements 164. When the user adds a new Media 170 to a Set, he is in actually nesting one element 164 (the new Media 170) inside another element 164 (the Element 164 that defines the Set). Modifying the Media 170 may be done through the UI component 102 and/or the AC component 104 tools and may be supplemented by Plug-In Modules 138 and/or Add-On Modules 144.

Elements, Sets, or Datum may be tagged to denote parts and entire items and/or parts of items may be tagged. Each type of data may use a customized set of tags and the tags may denote parts in a display (2d), an interface (data), a space (3d), time, frequency, text, datatype, position, meta-data, color and/or any other quantifiable criterion. Additionally, tags may overlap, they be nested to denote additional relationships (ownership), they may be attached to and/or embedded within data and/or they may be related to one another. Furthermore, a user may use relations to navigate through and/or identify data. Once the user has created a File with the Media 170, the user may tag that media 170. For example, the user may denote a small section of an image showing a gunshot wound with one tag, a short section of a long audio file with a second tag where the wound is described, a 3d portion of a digital model showing the trajectory of the shot with a third tag and a block of text describing a witness testimony of the shooting in a report with a fourth tag. Tags may be nested. For example, a user may tag a certain time clip of video and then add tags within that tag to highlight certain sections of the screen and then nest other tags within those to isolate certain colors or frequencies of sound. The user may then connect those tagged parts to each other conferring meaning and allowing the user to quickly cross reference and navigate though the tagged information. Tags may also be stored in collections attached to other data objects, wherein each set of tags may fully denote a region of the data to which it is attached. Different data may require different tag sets, depending on predetermined criterion, such as the modality (image, 3d, audio, video all require different tag sets to denote a region). A tag may hold collections of relations to other tags and a tag may denote overlapping regions of data. Nested tags may or may not overlap.

Data may be persisted to a flat file, may be persisted as an Element 164 and/or as Set and/or may be encrypted and/or compressed. Furthermore, data may be persisted as binary and/or XML (SOAP) and/or in read-only format. Data may be persisted to a database, as Datum, as DataSet and/or stored to any available DataFile database. Non-parsable data may be stored as generic objects and then cast back to be base classes in Core and/or derived classes in the appropriate Object Oriented Datastore. Parsable and/or non-parsable sub-data may be stored in separate tables for flexibility and speed and Parsable data 166 may be available for searching. Non-parsable 168 data may be encrypted and/or compressed and all data may be periodically auto-saved to a temporary local file. The user may save files and/or individual Media 170 to a flat file. The user may also choose to save data, files and/or individual Media 170 in read-only and/or read write format. The user may select if they want to use encryption and/or compression and/or chose the final output format. The user may choose to save to a database. Data may be saved in multiple locations. For example, one location may be used for parsed data and another location may be used for unparsed data. Parsed data 166 may be available for searching and/or sorting. Data may be persisted to any available Database. The user may choose from a list of available databases to which the data may be saved. Databases may be managed by the Database Management Module 132 via the Data Management Module 130.

Files may be stored in separate databases using different identifiers. If Elements 164 and/or Sets are stored in multiple datastores/databases, the application may resolve differences between files when one is saved back to the other using a matrix of database unique ids, application unique ids, timestamps and permissions. For example, User_A may save a file to their database (database_A) identified as File_A. User_A may send a copy of the file to User_B who then saves the file to their database (database_B). There are now two separate, disconnected versions of the files. User_B changes the file identifier to File_B. User_A modifies the File_A on Database_A and User_B modifies File_B on Database_B. User_B then sends File_B back to User_A. DMT 100 recognizes that File_A and File_B are actually the same file. User_A can see File_B using identifiers from either database. DMT 100 compares the contents, identifies the differences, makes suggestions for reconciling the differences, allows the user to choose (and/or automatically identifies), what, if any data in their file (File_A) is changed and saves the file. Each Element 164 may contain a set of DatastoreReferences, uniquely identifying the location of a save using several factors, including, but not limited to, machine ids, server ids, user ids, database ids, disk ids, volume ids and so on. Each reference may store the users, permissions and timestamps of edits to that Element 164. When two elements 164 come together, they may determine if they are the same element 164 by searching for common DataStoreReferences. They may then use the permissions and/or timestamps to determine what the data is. When two versions of an Element 164 are reconciled (including nested sub-elements), the permissions and timestamps for each Element 164 may be compared and reconciliation suggestions may be made by the DMT 100. For example, items in Element_A that have been added but that are not in Element_B would be able to be added. Items that have been removed from Element_A and that are still in Element_B would be able to be restored. Items that have been modified in one would be able to be updated in the other. Items that have been modified in both would allow the user to choose which version to maintain.

Flat files may be encrypted and compressed. Unparsed data 166 in databases may be encrypted and compressed. Elements 164 may be password protected. A single Element 164 may be password protected. An Element 164 and it's sub-Elements may be protected. The user may save a data to a flat file. The user may choose to save it in any format suitable to the desired end purpose, including, but not limited to, Binary and XML. The user may choose to encrypt and/or compress the file when saving. Default encryption may be included. The user may select a Media and password protect it. Other users may need to use the same password or individual passwords before they can modify and/or delete the media. The user may also password protect a partial and/or an entire file. If the user protects an individual media 170 and then the entire file using two different passwords, then another user must use both passwords to edit that individual media. By default, static key encryption may be used on all files and/or unparsed database data. Public Key encryption may also be available and may be maintained by the user and/or an administrator. Compression may be used to reduce the file size and/or speed transmission over networks and/or the internet.

Data may be built into multi-media presentations. A user may construct a number of slides. Each slide may link to a DataSet, Datum, Sub-Datum and/or RTD tagged part of a DataSet, Datum or Sub-Datum. Both read-only and read-write data may be built into presentations. Data may be printed. A user may add custom headers and footers. Headers and footers may be persisted locally and/or on the database. Local headers and footers may be synched with the database. Items in the database may be copied to the local environment and items in the local environment may be copied to the database. Discrepancies may be evaluated by the system and the user and resolved. Data may be saved in read only format. Data may be emailed. A user may build multi media presentations. From a set of 50 media, the user may select several to display or may show selected media in a desired order. The user may also use RTD to link presentation to tagged parts of data. Emailed data may be encrypted and/or compressed. A user may deliver data in a read-only format, wherein read only data may be shown in DataFile and/or DataPlayer.

Both local and online help may be provided and local help files may be updated from online versions. Online libraries may be provided and local help files may be updated from online versions and/or electronic media, such as optical disc and/or magnetic media. The application may include an update utility that periodically checks for updated components and libraries and uploads and installs them. Online support may be provided through FAQ, automated systems and/or multi-level human support.

By way of example, a DMT 100 in accordance with an exemplary embodiment is illustrated and may be operated as follows. Consider the situation where an investigation of a murder victim is initiated and investigated by three different police officers, wherein two of the three police officers has a PC/PDA that is operating the DMT 100 and the third police officer is using a tablet PC operating the DMT 100 in conjunction with a digital video camera. Upon arrival at the scene of the crime, the first investigating officer begins his investigation by capturing real-time audio statements from potential witnesses directly into DMT 100 operating on a first PC/PDA. Simultaneously, the second investigating officer begins her investigation by capturing real-time audio statements from potential witnesses directly into DMT 100 operating on a second PC/PDA. Meanwhile, using the digital video camera and the tablet PC, the third investigating officer captures video of the crime scene directly to the DMT 100. Additionally, using the diagram templates built-into DMT 100 and palettes of icons provided by the Crime Scene Plug-In Module, the third investigating officer takes notes of the crime scene and digitally documents the position of the dead body and any objects in the room. This allows the third investigating officer to digitally record the position of the body, any murder weapons, any shell casings, broken glass, finger prints, fibers and any blood stains. Additionally, several other police support personnel are capturing digital images of the crime scene/evidence using separate digital cameras. It should be appreciated that as each piece of data is being entered into the DMT 100, the data is being time/date stamped as well as being tagged to identify which investigator/personnel is entering the data and to which case/file the data is associated.

After all of the data regarding the crime scene has been collected by the three investigating officers and the police support personnel, each of the parties submits their data to a DMT 100 central data store. This may be accomplished via download using the Internet, Intranet, Extranet and/or via wireless download. For example, the first two investigating officers submit their data and report via a wireless link to the central data store, while the third investigating officer submits his data via an Internet connection and the police support personnel submit their data via a police Intranet. During submission, each person downloading information outside of a DMT 100 includes a data tag (i.e. case number, a personnel identifier) and a time/date stamp. Using the data tag and the time/date stamp, the DMT 100 intelligently organizes, time stamps the date submitted to the central data store and checks-in submitted data in a format that allows the data to be searched, retrieved, edited with proper permission, saved, and checked-out. It should be appreciated that although the example above uses a case number and/or a personnel identifier to correlate data, any data tag suitable to the desired end purpose may be used to correlate data.

Meanwhile, the investigation continues and the body is delivered to the Medical Examiner's Office for further examination, wherein the investigators have the option of including the data they obtained using a read-format provided by the DMT 100. In this case, the third investigating officer provides his data to the Medical Examiner (i.e. video and report) as read-only data. This may be accomplished by exporting the data from the DMT 100 on the third investigator's tablet PC into the read-only DataPlayer format and providing this data to the Medical Examiner via a storage medium and/or via data transmission. This allows the Medical Examiner to review the third investigators data, containing the video of the crime scene as well as the third investigators report, prior to beginning the post-mortem examination. It should be appreciated that all of the data collected at the crime scene may be merged together at the crime scene and communicated to the Medical Examiner prior to submission into the central data store. In this case, each of the data collectors may still be required to enter the data into the central store separately. When the merged collection of data is submitted to the central data store, the DMT 100 may correlate and separate data the individual submissions from the merged submission via the data tags to prevent redundant stores of data and to ensure that all data has been submitted. For example, if the merged data set includes more data than the individual data submissions, then the data submissions would not match and a flag would be raised to identify where the data incongruity exists.

As the post-mortem examination proceeds, the Medical Examiner (ME) digitally documents points of trauma on the body using an input device, such as a PC tablet, operating the DMT 100. The trauma to the body may be documented using anatomy diagrams that may be included with the DMT 100 and/or palettes of trauma icons provided by the Medical Examiner Plug-In Module. Each icon may have an associated legend that allows the ME to add any textual/photographic/video information about each trauma icon, such as the dimensions of the wound, the dept of the wound, the location of the wound on the body and/or a description of the wound. Additionally, the ME may choose from a series of standard anatomy and/or skeletal diagrams and/or the ME may import their other diagrams into the DMT 100. Furthermore, any remaining data, remarks, photographs, video, etc. . . . may be added to the data obtained during the post-mortem by importing and storing the additional data into the DMT 100.

Upon completion of the post-mortem examination, the ME exports all or some of the digital information from the examination to the read-only DMT 100 format and provides this data to the investigators who submit the post-mortem examination data to the data store and tag the data for correlation with the other data related to that particular case number. This data, as with all DMT collections, may be transmitted wirelessly, via a LAN, or via Internet, Intranet, E-mail, external storage, flash memory device, and/or any other transmission method/device and/or storage medium. The investigators are now able to review the post-mortem examination data by checking the data out of the DMT 100 in a read-only format. It should be appreciated that in this example, although the Medical Examiner may assign an agency-specific case number to the autopsy that is different from the police department case number for this investigation, upon submission to the police department data store, the ME data may be tagged for identification/relation to a particular case file number. As such, the DMT 100 can intelligently compare, correlate and/or combine the Medical Examiner data with the police investigation data. Moreover, although the two files may be combined the Medical Examiners data portion will remain in a read-only format to the police department and vice versa. The completed case file containing all of the collected data may then be communicated to the District Attorney's Office in a read-only, DMT format for review and submission to judge and jury.

It should be appreciate that although the above example relates to the medical-legal and criminal justice fields, the DMT 100 is not limited to any specific industry and thus may be customized as desired. The power of DMT 100 lies in it's flexibility to function within any environment, utilizing industry-specific Plug-In Modules and Add-On Modules. As such, the DMT 100 serves as a generic wrapper for any person and/or industry that collects, archives, maintains, searches, retrieves, and/or presents data and/or that relies on reliable, consistent and repeatable data collection and/or integrity. Thus, it should be appreciated that industry specific Plug-In Modules are available. For example, the insurance industry may be provided with a DMT insurance Plug-In Module for insurance industry specific data tracking and integrity, thus allowing insurance adjusters/investigators the same functionality and flexibilities in a real world environment.

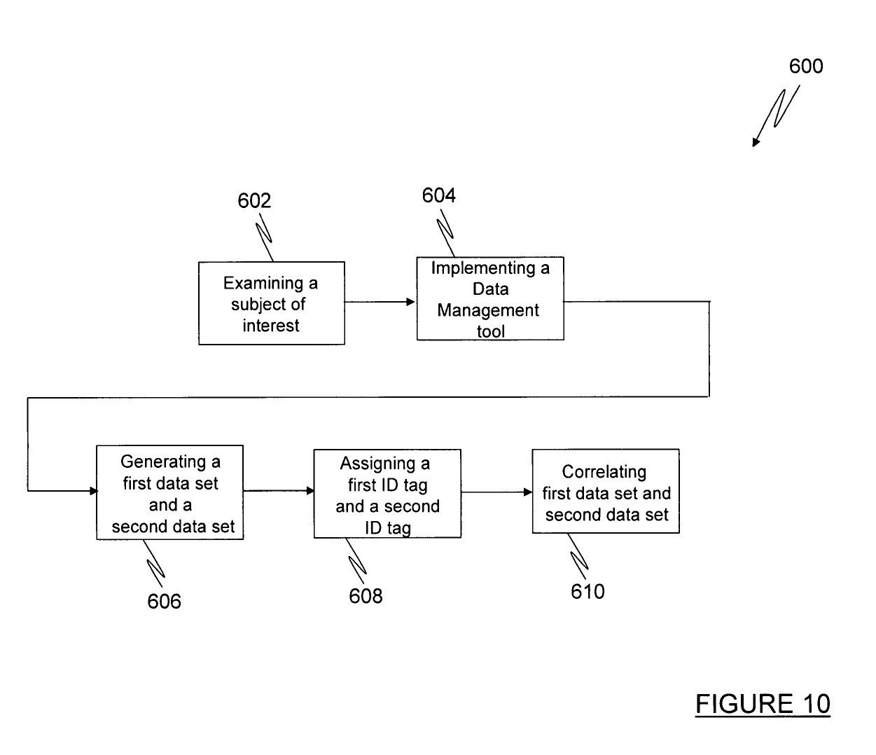

Referring to FIG. 10, a high level block diagram illustrating a method 600 for implementing the data management tool of FIG. 1 is shown and includes examining a subject of interest, as shown in operational block 602 and implementing the DMT 100, as shown in operational block 604. The DMT 100 includes generating a first data set and a second data set, shown in operational block 606, wherein the first data set is generated independently from the second data set. Furthermore, the DMT includes assigning a first identification tag to the first data set and a second identification tag to the second data set, as shown in operational block 608. The DMT further includes correlating the first data set with the second data set to obtain a final data set in a manner responsive to at least one of the first identification tag and the second identification tag, as shown in operational block 610.

As described above, the methods and embodiments described hereinabove and in the several Figures may be embodied in the form of computer-implemented processes and apparatuses for practicing those processes. Any computer-implemented language and/or device may be used to implement the method(s) disclosed herein. The methods and embodiments described hereinabove and in the several Figures may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) may be updated to implement the invention. The methods and embodiments described hereinabove and in the several Figures may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments may configure the microprocessor to create specific logic circuits.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for managing data using a data management scheme, the method comprising:
generating a first data set and a second data set, wherein said first data set is generated independently from said second data set;
introducing said first data set and said second data set into the data management scheme, wherein the data management scheme assigns a first identification tag to said first data set and a second identification tag to said second data set; and
responsive to at least one of said first identification tag and said second identification tag, correlating said first data set with said second data set to obtain a final data set.

2. The method according to claim 1, wherein said generating includes generating at least one of said first data set and said second data set via a data recording device.

3. The method of claim 2, wherein said data recording device is at least one of a Personal Digital Assistant, a Personal Computing device, a Laptop Computing device, a Video Camera, a Digital Camera and a Film Base Camera.

4. The method according to claim 2, wherein said generating includes editing at least one of said first data set and said second data set via said data recording device.

5. The method according to claim 1, wherein said introducing includes introducing at least one of said first data set and second data set into the data management scheme via at least one of a wireless network, a hardwired network and a storage medium.

6. The method according to claim 1, wherein said introducing includes introducing at least one of said first data set and second data set into the data management scheme via at least one of an Internet connection, an Extranet connection and an Intranet connection.

7. The method according to claim 1, wherein said introducing includes introducing at least one of said first data set and second data set into the data management scheme independent of the other of said first data set and said second data set.

8. The method according to claim 1, wherein at least a portion of said first identification tag is identical to at least a portion of said second identification tag.

9. The method according to claim 1, wherein said correlating includes merging at least a portion of at least one of said first data set and said second data set with at least a portion of the other of said first data set and said second data set to obtain said final data set.

10. The method according to claim 1, wherein said correlating further includes generating said final data set in a read-only format.

11. The method according to claim 1, wherein said introducing includes introducing said first data set and said second data set in at least one of a video format, an audio format, an image format, and a text format.

12. The method according to claim 1, wherein said correlating includes generating at least a portion of said final data set in at least one of a video format, an audio format, an image format, and a text format.

13. A method for implementing a data management scheme, the method comprising:
examining a subject of interest; and
implementing the data management scheme, wherein the data management scheme includes,
generating a first data set and a second data set, wherein said first data set is generated independently from said second data set;
assigning a first identification tag to said first data set and a second identification tag to said second data set; and
responsive to at least one of said first identification tag and said second identification tag, correlating said first data set with said second data set to obtain a final data set.

14. The method according to claim 13, wherein said generating includes generating at least one of said first data set and said second data set via a data recording device, wherein said data recording device is at least one of a Personal Digital Assistant, a Personal Computing device, a Laptop Computing device, a Video Camera, a Digital Camera and a Film Base Camera.

15. The method according to claim 14, wherein said generating includes editing at least one of said first data set and said second data set via said data recording device.

16. The method according to claim 13, further comprising tracking edits of at least one of said first data set and said second data set and generating a revision history responsive to said tracking.

17. The method according to claim 13, wherein said introducing includes introducing at least one of said first data set and second data set into the data management scheme via at least one of a wireless network, a hardwired network and a storage medium.

18. The method according to claim 13, wherein said introducing includes introducing at least one of said first data set and second data set into the data management scheme via at least one of an Internet connection, an Extranet connection and an Intranet connection.

19. The method according to claim 13, wherein said introducing includes introducing at least one of said first data set and second data set into the data management scheme independent of the other of said first data set and said second data set.

20. The method according to claim 13, wherein said correlating includes merging at least a portion of at least one of said first data set and said second data set with at least a portion of the other of said first data set and said second data set to obtain said final data set.
